(19) United States
(12) Patent Application Publication
(10) Pub. No.: US 2023/0345554 A1
(43) Pub. Date: Oct. 26, 2023

(54) WIRELESS CONNECTION DEVICE

(71) Applicant: NTT DOCOMO, INC., Chiyoda-ku, Tokyo (JP)

(72) Inventors: Maiko MURAKAMI, Chiyoda-ku, Tokyo (JP); Akio GOUDA, Chiyoda-ku, Tokyo (JP); Masaki MORISHITA, Chiyoda-ku, Tokyo (JP)

(21) Appl. No.: 18/005,068

(22) PCT Filed: Dec. 22, 2021
(86) PCT No.: PCT/JP2021/047659

§ 371 Date: Jan. 11, 2023

(30) Foreign Application Priority Data
Jan. 14, 2021 (JP) 2021-004261

(51) Int. Cl. H04W 76/10; H04W 8/00

(52) U.S. Cl. CPC H04W 76/10; H04W 8/005

(57) ABSTRACT

A wireless connection device that performs wireless communication with a terminal which is a communication target by wirelessly connecting to the terminal using a predetermined protocol includes: a terminal state acquiring unit configured to acquire an advertisement signal which is used to cause the wireless connection device to recognize presence of the terminal and which includes terminal state information indicating a state of the terminal; a determination unit configured to determine that wireless connection to the terminal is to be performed when the terminal state information indicates a predetermined state indicating that a user is using the terminal; and a connection processing unit configured to perform a wireless connection process to the terminal to which it is determined that connection is to be performed by the determination unit using the predetermined protocol.

### TECHNICAL FIELD

The present invention relates to a wireless connection device.

### BACKGROUND ART

A wireless connection device that is connected to a terminal such as a smartphone, for example, through short-range wireless communication such as Bluetooth (registered trademark) has become widespread. The wireless connection device outputs, for example, audio received from the terminal or the like. When a predetermined advertisement signal transmitted from a paired terminal is received, the wireless connection device performs a connection process to the terminal and sets up connection to the terminal. A technique of connecting a wireless connection device to a desired terminal on the basis of a radio field intensity when a plurality of terminals which may serve as connection targets are present in a communication coverage of a wireless connection device is known (for example, see Patent Literature 1).

### CITATION LIST

### Patent Literature

[Patent Literature 1] Japanese Unexamined Patent Publication No. 2016-9888

### SUMMARY OF INVENTION

### Technical Problem

With the method of connection to a terminal based on a radio field intensity, a terminal present closest to the wireless connection device may be automatically connected and thus a terminal desired by a user may not be connected to the wireless connection device. Also, a method of reconnecting to a most-recently-connected terminal out of a plurality of terminals is known. However, with this method, a terminal desired by a user may not be connected to the wireless connection device.

Therefore, the present invention was made in consideration of the aforementioned circumstances and an objective thereof is to provide a wireless connection device that may easily realize wireless connection to a desired terminal.

### Solution to Problem

In order to achieve the aforementioned objective, according to an aspect of the present invention, there is provided a wireless connection device that performs wireless communication with a terminal which is a communication target by wirelessly connecting to the terminal using a predetermined protocol, the wireless connection device including: a terminal state acquiring unit configured to acquire an advertisement signal which is used to cause the wireless connection device to recognize presence of the terminal and which includes terminal state information indicating a state of the terminal; a determination unit configured to determine that wireless connection to the terminal is to be performed when the terminal state information indicates a predetermined state indicating that a user is using the terminal; and a connection processing unit configured to perform a wireless connection process to the terminal to which it is determined that connection is to be performed by the determination unit using the predetermined protocol.

According to this aspect, since the terminal state information indicating a state of a terminal is acquired, the wireless connection device may recognize whether the terminal is in the predetermined state in which a user is using the terminal. Accordingly, the terminal which is being used by a user may be connected as a desired terminal to the wireless connection device.

### Advantageous Effects of Invention

According to the aspect of the present invention, a wireless connection device that may easily realize wireless connection to a desired terminal may be provided.

### BRIEF DESCRIPTION OF DRAWINGS

FIG. 1 is a diagram illustrating a system configuration of a wireless connection system including a wireless connection device according to an embodiment.

FIG. 2 is a block diagram illustrating a functional configuration of the wireless connection device according to the embodiment.

FIG. 3 is a block diagram illustrating a functional configuration of a terminal that is wirelessly connected to the wireless connection device.

FIG. 4 is a block diagram illustrating a hardware configuration of the wireless connection device.

FIG. 5 is a sequence diagram illustrating operations of a wireless connection method in the wireless connection system.

FIG. 6 is a sequence diagram illustrating operations of a wireless connection method in the wireless connection system.

FIG. 7 is a diagram illustrating an example of predetermined conditions associated with a position of a terminal for determining whether wireless connection is to be performed.

FIG. 8 is a diagram illustrating another example of predetermined conditions associated with a position of a terminal for determining whether wireless connection is to be performed.

FIG. 9 is a diagram illustrating another example of predetermined conditions associated with a position of a terminal for determining whether wireless connection is to be performed.

FIG. 10 is a diagram illustrating another example of predetermined conditions associated with a position of a terminal for determining whether wireless connection is to be performed.

FIG. 11 is a diagram illustrating a configuration of a wireless connection program.

### DESCRIPTION OF EMBODIMENTS

A wireless connection device according to an embodiment of the present invention will be described below with reference to the accompanying drawings. As far as possible, the same elements will be referred to by the same reference signs and repeated description thereof will be omitted.

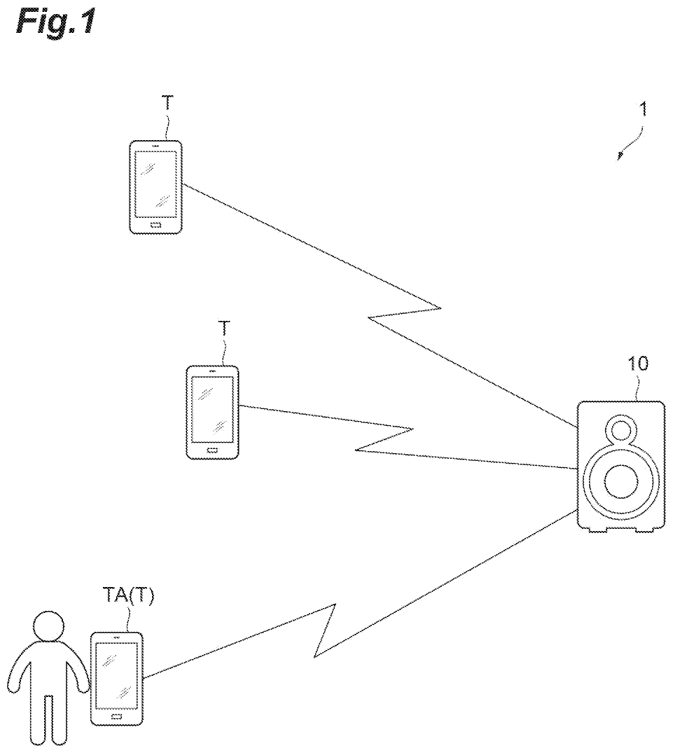

FIG. 1 is a diagram illustrating a system configuration of a wireless connection system including a wireless connection device according to the embodiment. As illustrated in FIG. 1, the wireless connection system 1 includes a wireless connection device 10 and a terminal T.

The wireless connection device 10 is a device that performs wireless communication with the terminal T by wirelessly connecting to the terminal T which is a communication target on the basis of a predetermined protocol. The terminal T is a device that is operated by a user. A device forming the terminal T is not particularly limited and may be, for example, a mobile terminal such as a high-function mobile phone (a smartphone), a mobile phone, or a personal digital assistant (PDA).

Wireless communication based on a predetermined protocol is, for example, short-range wireless communication and is, for example, wireless communication based on Bluetooth (registered trademark). The wireless connection device 10 may be, for example, a so-called Bluetooth speaker. When the wireless connection device 10 is a Bluetooth speaker, the wireless connection device 10 acquires audio data from the terminal T wirelessly connected thereto, decodes audio data as needed, and outputs audio.

As illustrated in FIG. 1, when a plurality of terminals T which are wirelessly connectable are present in a communication coverage, a terminal T other than a terminal TA which is desired by a user may be connected to the wireless connection device 10. The wireless connection device 10 according to this embodiment easily realizes wireless connection to a desired terminal TA (T).

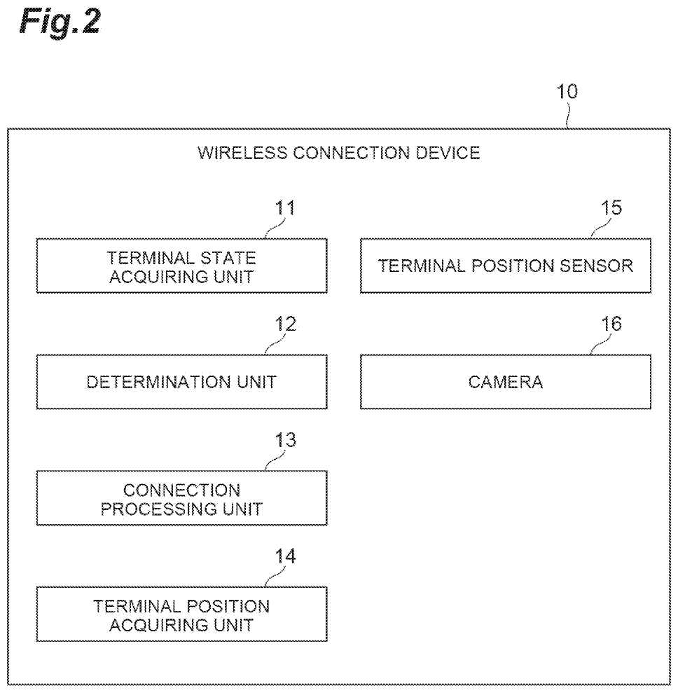

FIG. 2 is a block diagram illustrating a functional configuration of the wireless connection device 10 according to the embodiment. As illustrated in FIG. 2, the wireless connection device 10 functionally includes a terminal state acquiring unit 11, a determination unit 12, a connection processing unit 13, and a terminal position acquiring unit 14. The wireless connection device 10 may include devices such as a terminal position sensor 15 and a camera 16 (an imaging device). The functional units of the wireless connection device 10 will be described later in detail.

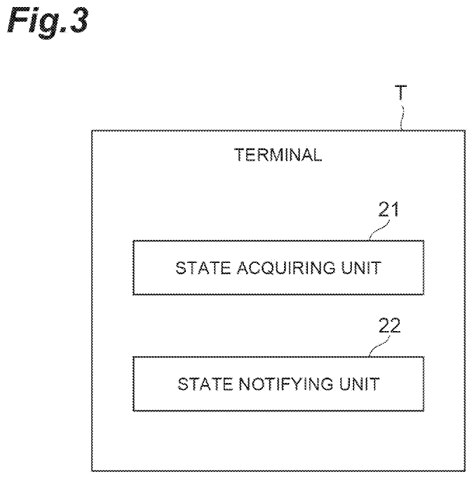

FIG. 3 is a diagram illustrating a part of a functional configuration of the terminal T. As illustrated in FIG. 3, the terminal T includes a state acquiring unit 21 and a state notifying unit 22.

The state acquiring unit 21 acquires a state of the terminal T. Specifically, the state acquiring unit 21 acquires information indicating the state of the terminal T which may be used to determine whether a user is using the terminal T with reference to information indicating an internal state of the terminal T.

The state acquiring unit 21 may acquire, for example, information indicating whether a screen of the terminal T is being displayed. The state acquiring unit 21 may acquire information indicating whether an operation of the terminal T is ready to be received, that is, whether the terminal T is in a locked state or not.

The state acquiring unit 21 may acquire information indicating whether a user's operation has been detected by a predetermined sensor mounted in the terminal T. More specifically, the state acquiring unit 21 may acquire information indicating whether an acceleration equal to or greater than a predetermined value has been detected by an acceleration sensor mounted in the terminal T. The state acquiring unit 21 may acquire information indicating whether an input to a touch panel mounted in the terminal T has been detected by a touch sensor for the touch panel. The state acquiring unit 21 may acquire information indicating whether gripping of the terminal T is detected using a grip sensor mounted in the terminal T.

The state notifying unit 22 notifies the wireless connection device 10 of information indicating the state of the terminal T as terminal state information. Specifically, since the terminal T broadcasts an advertisement signal for causing the wireless connection device 10 to recognize presence of the terminal T at predetermined time intervals in order to set up wireless connection between the terminal T and the wireless connection device 10, the state notifying unit 22 may add the terminal state information to the advertisement signal and transmits the resultant signal.

In the block diagram illustrated in FIG. 2, blocks of functional units are illustrated. These functional blocks (constituents) are realized by an arbitrary combination of at least one of hardware and software. The realization method of the functional blocks is not particularly limited. That is, the functional blocks may be realized by a single device which is physically or logically coupled, or may be realized by two or more devices which are physically or logically separated and which are directly or indirectly connected (for example, in a wired or wireless manner). The functional blocks may be realized by combining software with the single device or the two or more devices.

The functions include determining, deciding, judging, calculating, computing, processing, deriving, investigating, searching, ascertaining, receiving, transmitting, outputting, accessing, resolving, selecting, choosing, establishing, comparing, supposing, expecting, considering, broadcasting, notifying, communicating, forwarding, configuring, reconfiguring, allocating mapping, and assigning, but are not limited thereto. For example, a functional block (constituent) for transmitting is referred to as a transmitting unit or a transmitter. As described above, the realizing method of each function is not particularly limited.

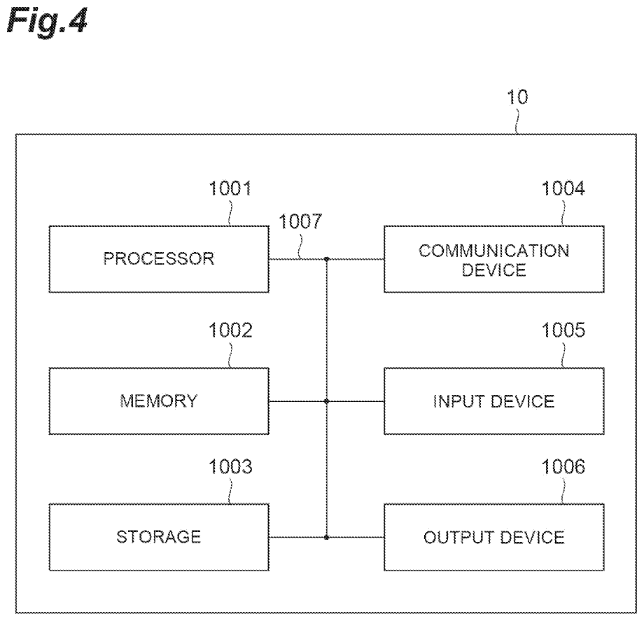

For example, the wireless connection device 10 according to an embodiment of the present disclosure may serve as a computer. FIG. 4 is a diagram illustrating an example of a hardware configuration of the wireless connection device 10 according to the embodiment. The wireless connection device 10 may be physically configured as a computer device including a processor 1001, a memory 1002, a storage 1003, a communication device 1004, an input device 1005, an output device 1006, and a bus 1007.

In the following description, the term “device” may be replaced with circuit, device, unit, or the like. The hardware configuration of the wireless connection device 10 may include one or more devices illustrated in FIG. 4 or may not include some devices thereof.

The functions of the wireless connection device 10 may be realized by reading predetermined software (programs) to hardware such as the processor 1001 and the memory 1002 and causing the processor 1001 to execute arithmetic operations and to control communication using the communication device 1004 or to control reading and/or writing of data with respect to the memory 1002 and the storage 1003.

The processor 1001 controls a computer as a whole, for example, by causing an operating system to operate. The processor 1001 may be configured as a central processing unit (CPU) including an interface with peripherals, a controller, an arithmetic operation unit, and a register. For example, the functional units 11 to 14 illustrated in FIG. 2 may be realized by the processor 1001.

The processor 1001 reads a program (a program code), a software module, data, or the like from the storage 1003 and/or the communication device 1004 to the memory 1002 and performs various processes in accordance therewith. As the program, a program that causes a computer to perform at least some of the operations described above in the embodiment is used. For example, the functional units 11 to 14 of the wireless connection device 10 may be realized by a control program which is stored in the memory 1002 and which operates in the processor 1001. The various processes described above are described as being performed by a single processor 1001, but they may be simultaneously or sequentially performed by two or more processors 1001. The processor 1001 may be mounted as one or more chips. The program may be transmitted from a network via an electrical telecommunication line.

The memory 1002 is a computer-readable recording medium and may be formed by, for example, at least one of a read only memory (ROM), an erasable programmable ROM (EPROM), an electrically erasable programmable ROM (EEPROM), and a random access memory (RANI). The memory 1002 may be referred to as a register, a cache, a main memory (a main storage device), or the like. The memory 1002 may store a program (a program code), a software module, and the like that may be executed to perform a wireless connection method according to an embodiment of the present invention.

The storage 1003 is a computer-readable recording medium and may be formed by, for example, at least one of an optical disc such as a compact disc ROM (CD-ROM), a hard disk drive, a flexible disk, a magneto-optical disc (for example, a compact disc, a digital versatile disc, or a Blu-ray (registered trademark) disc), a smart card, a flash memory (for example, a card, a stick, or a key drive), a floppy (registered trademark) disk, and a magnetic strip. The storage 1003 may be referred to as an auxiliary storage device. The storage media may be, for example, a database, a server, or another appropriate medium including the memory 1002 and/or the storage 1003.

The communication device 1004 is hardware (a transmitting and receiving device) that performs communication between computers via a wired and/or wireless network and is also referred to as, for example, a network device, a network controller, a network card, or a communication module.

The input device 1005 is an input device that receives an input from the outside (for example, a keyboard, a mouse, a microphone, a switch, a button, or a sensor). The output device 1006 is an output device that performs an output to the outside (for example, a display, a speaker, or an LED lamp). The input device 1005 and the output device 1006 may be configured as a unified body (for example, a touch panel).

The devices such as the processor 1001 and the memory 1002 are connected to each other via the bus 1007 for transmission of information. The bus 1007 may be formed by a single bus or may be formed by buses which are different depending on the devices.

The wireless connection device 10 may be configured to include hardware such as a microprocessor, a digital signal processor (DSP), an application-specific integrated circuit (ASIC), a programmable logic device (PLD), or a field-programmable gate array (FPGA), and some or all of the functional blocks may be realized by the hardware. For example, the processor 1001 may be mounted as at least one piece of such hardware.

The functional units of the wireless connection device 10 will be described below with reference back to FIG. 2. The terminal state acquiring unit 11 acquires an advertisement signal for causing the wireless connection device 10 to recognize presence of the terminal T. In this embodiment, the terminal state acquiring unit 11 receives and acquires an advertisement signal including terminal state information. As described above, the advertisement signal is a signal that is transmitted from the terminal T.

It is assumed that the terminal T which is a transmission source of the advertisement signal acquired by the terminal state acquiring unit 11 is ready to connect to the wireless connection device 10. The terminal T ready to connect to the wireless connection device 10 is a terminal that has exchanged information necessary for transmitting and receiving data to and from the wireless connection device 10 through previous wireless connection or the like. When wireless connection based on Bluetooth is used, the terminal T ready to connect to the wireless connection device 10 is a terminal paired with the wireless connection device 10. Pairing includes exchange of a key for encryption at the time of transmitting and receiving data.

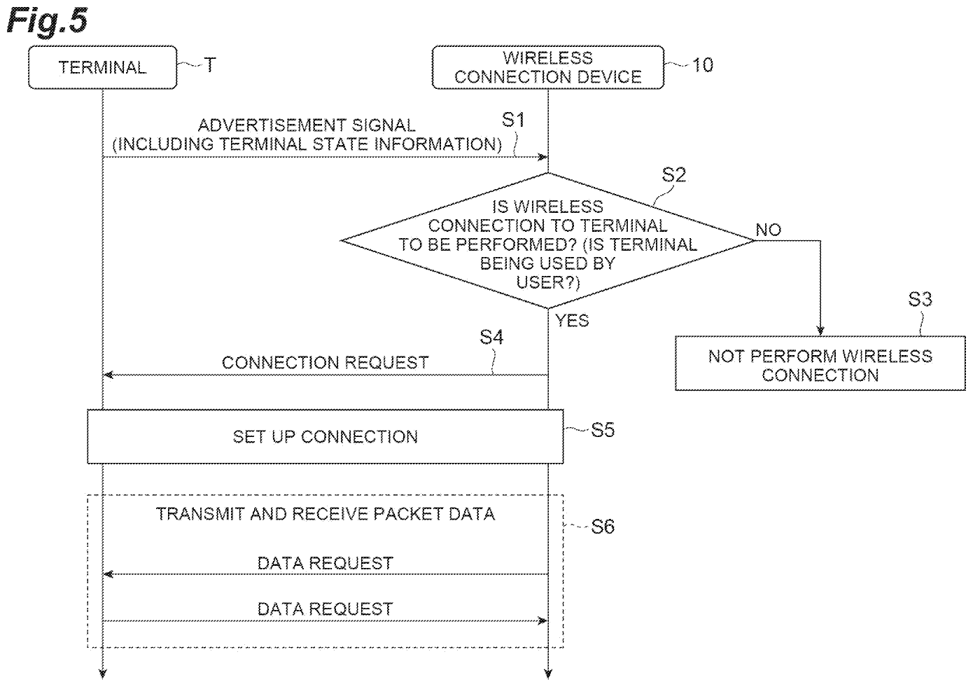

When the terminal state information indicates a predetermined state in which a user is using the terminal T, the determination unit 12 determines that the terminal T is to be wirelessly connected. Details of the determination unit 12 will be described later with reference to FIG. 5.

The connection processing unit 13 performs a wireless connection process to the terminal T to which it is determined that connection is to be performed by the determination unit 12 using a predetermined protocol (for example, Bluetooth). Details of the connection processing unit 13 will be described later with reference to FIG. 5.

The terminal position acquiring unit 14 acquires terminal position information indicating a position of a terminal T. Specifically, the terminal position acquiring unit 14 acquires at least one of a position of the terminal T, a change in position of the terminal T, and a distance to the terminal T as terminal position information on the basis of information acquired from the terminal position sensor 15, the camera 16, and the like.

The terminal position sensor 15 may be a sensor that detects distances to terminals T on the basis of radio field intensities emitted from the terminals T.

The terminal position sensor 15 may be a Time-of-Flight (ToF) sensor. The terminal position sensor 15 formed by the ToF sensor emits light such as infrared light or laser light to a terminal T and detects a distance to the terminal T on the basis of a time until light reflected by the terminal T is detected.

The terminal position sensor 15 may be a positioning sensor based on an existing ultra-wide band (UWB) technique. The terminal position sensor 15 formed by a positioning sensor based on the UWB technique detects a position of the terminal T relative to the wireless connection device 10.

The terminal position sensor 15 may be an existing depth sensor. The terminal position sensor 15 formed by a depth sensor may detect a distance to a terminal T.

The camera 16 forms an example of an imaging device and images a user of a terminal T. The image of the user captured by the camera 16 is provided for identifying the terminal T carried by the user.

FIG. 5 is a sequence diagram illustrating an example of operations of a wireless connection method in the wireless connection system 1.

In Step S1, a terminal T broadcasts an advertisement signal. The state notifying unit 22 adds terminal state information to the advertisement signal and transmits the advertisement signal. The terminal state acquiring unit 11 of the wireless connection device 10 acquires the terminal state information along with the advertisement signal.

In Step S2, the determination unit 12 determines that wireless connection to the terminal T is to be performed when the terminal state information indicates a predetermined state indicating that a user is using the terminal T.

Specifically, when the terminal state information is information indicating whether a screen of the terminal T is being displayed, the determination unit 12 determines that wireless connection to the terminal T is to be performed when the terminal state information indicates that the screen of the terminal T is being displayed.

When the terminal state information is information indicating whether an operation on the terminal T is ready to be received, that is, whether the terminal T is in a locked state or not, the determination unit 12 determines that wireless connection to the terminal T is to be performed when the terminal state information indicates that the terminal T is in an unlocked state.

When the terminal state information is information indicating whether a user's operation has been detected by a predetermined sensor mounted in the terminal T, the determination unit 12 determines that wireless connection to the terminal T is to be performed when the terminal state information indicates that a user's operation has been detected by the sensor.

When it is determined in Step S2 that the user is not using the terminal T, the routine proceeds to Step S3. In Step S3, the determination unit 12 determines that wireless connection to the terminal T is not to be performed.

In Step S4, the connection processing unit 13 of the wireless connection device 10 transmits a connection request based on a predetermined communication protocol to the terminal T to which it is determined that connection is d to be performed in Step S2.

In Step S5, wireless connection is set up between the terminal T having received the connection request and the wireless connection device 10 after predetermined information based on a communication protocol has been transmitted and received therebetween.

In Step S6, transmission and reception of packet data between the terminal T and the wireless connection device 10 is performed, for example, in a manner including a request for data and a response thereto.

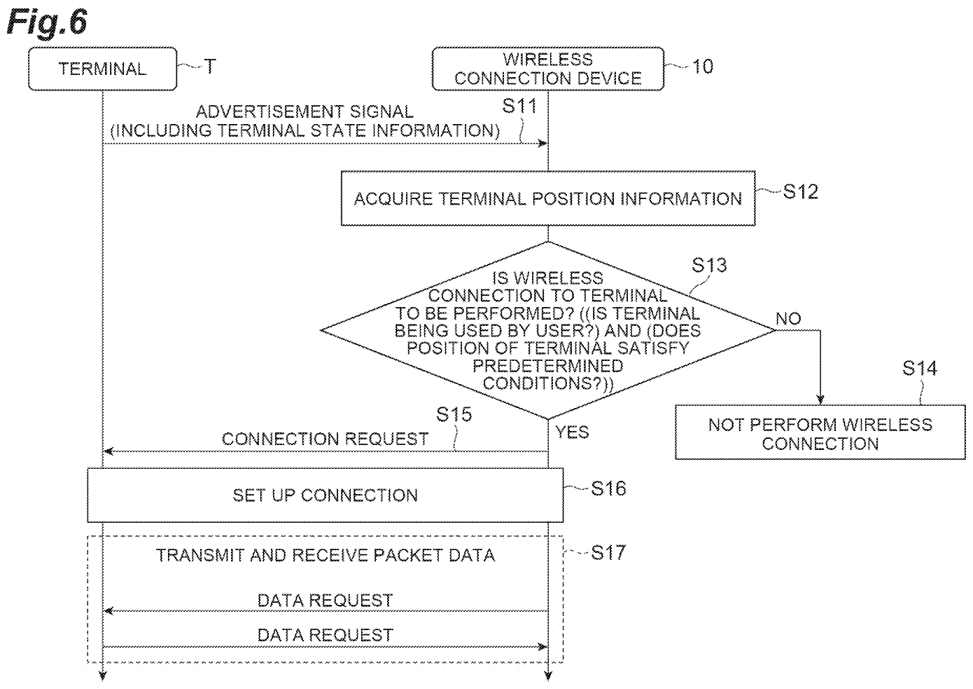

FIG. 6 is a sequence diagram illustrating another example of operations of the wireless connection method in the wireless connection system 1.

In Step S11, a terminal T broadcasts an advertisement signal. The state notifying unit 22 adds terminal state information to the advertisement signal and transmits the advertisement signal. The terminal state acquiring unit 11 of the wireless connection device 10 acquires the terminal state information along with the advertisement signal.

In Step S12, the terminal position acquiring unit 14 of the wireless connection device 10 acquires terminal position information indicating a position of the terminal T. Specifically, the terminal position acquiring unit 14 acquires at least one of a position of the terminal T, a change in position of the terminal T, and a distance to the terminal T as the terminal position information on the basis of information acquired from the terminal position sensor 15.

In Step S13, the determination unit 12 determines that wireless connection to the terminal T is to be performed. Specifically, when the terminal state information indicates a predetermined state indicating that a user is using the terminal T and the position (including the position, the change in position, the distance, and a change in distance) of the terminal T satisfies predetermined conditions, the determination unit 12 determines that wireless connection to the terminal T is to be performed.

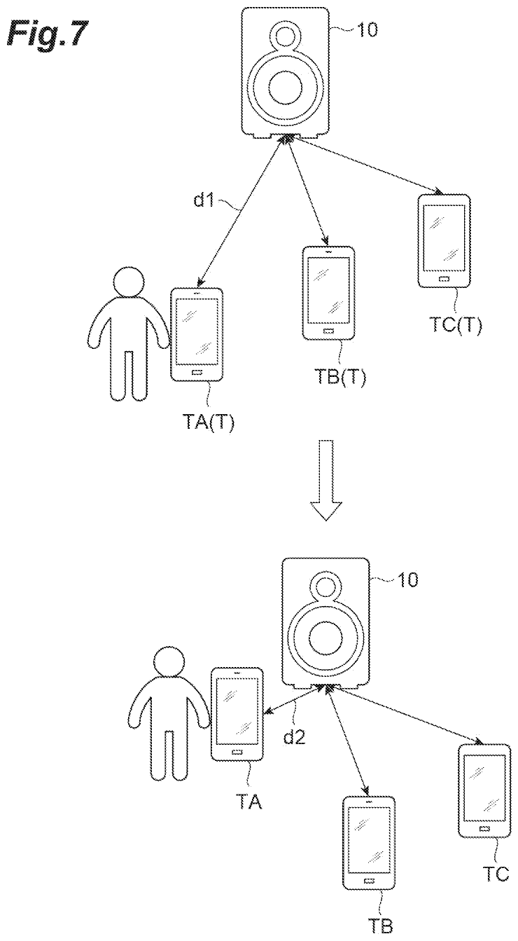

Determination of whether the terminal state information indicates the predetermined state indicating that the user is using the terminal T is the same as the determination of Step S2 in the sequence diagram illustrated in FIG. 5, and thus description thereof will be omitted. An example of Step S13 in which it is determined whether the position of the terminal T satisfies predetermined conditions will be described below with reference to FIGS. 7 to 10.

FIG. 7 is a diagram illustrating a first example of predetermined conditions associated with a position of a terminal for determining whether wireless connection is to be performed. The determination unit 12 determines that wireless connection to a terminal T with a largest decreasing distance to the wireless connection device 10 per predetermined unit time is to be performed out of a plurality of terminals TA, TB, and TC of which terminal state information indicates the predetermined state in which a user is using the corresponding terminal T. Specifically, the terminal position acquiring unit 14 of the wireless connection device 10 acquires distances to the plurality of terminals TA, TB, and TC of which terminal state information indicates the predetermined state in which a user is using the corresponding terminal T, for example, on the basis of information detected by the terminal position sensor 15. For example, the terminal position acquiring unit 14 acquires a distance d1 from the wireless connection device 10 to the terminal TA at a certain time and a distance d2 from the wireless connection device 10 to the terminal TA after a predetermined unit time has elapsed thereafter. Similarly, the terminal position acquiring unit 14 acquires distances from the wireless connection device 10 to the terminals TB and TC at a certain time and after a unit time has elapsed thereafter. Then, the determination unit 12 determines that wireless connection to the terminal TA with the largest decreasing distance (d2−d1) to the wireless connection device 10 per unit time is to be performed.

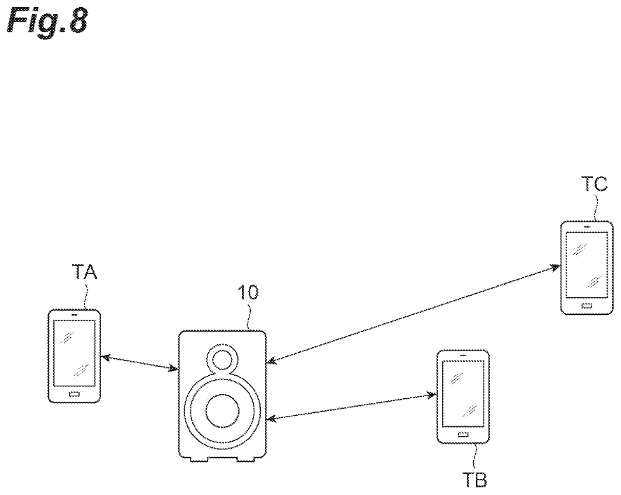

FIG. 8 is a diagram illustrating a second example of predetermined conditions associated with a position of a terminal for determining whether wireless connection is to be performed. The determination unit 12 determines that wireless connection to a terminal T with a smallest distance to the wireless connection device 10 is to be performed out of a plurality of terminals TA, TB, and TC of which terminal state information indicates the predetermined state in which a user is using the corresponding terminal T. Specifically, the terminal position acquiring unit 14 of the wireless connection device 10 acquires distances to the plurality of terminals TA, TB, and TC of which terminal state information indicates the predetermined state in which a user is using the corresponding terminal T, for example, on the basis of information detected by the terminal position sensor 15. Then, the determination unit 12 determines that wireless connection to the terminal TA with the smallest distance to the wireless connection device 10 is to be performed.

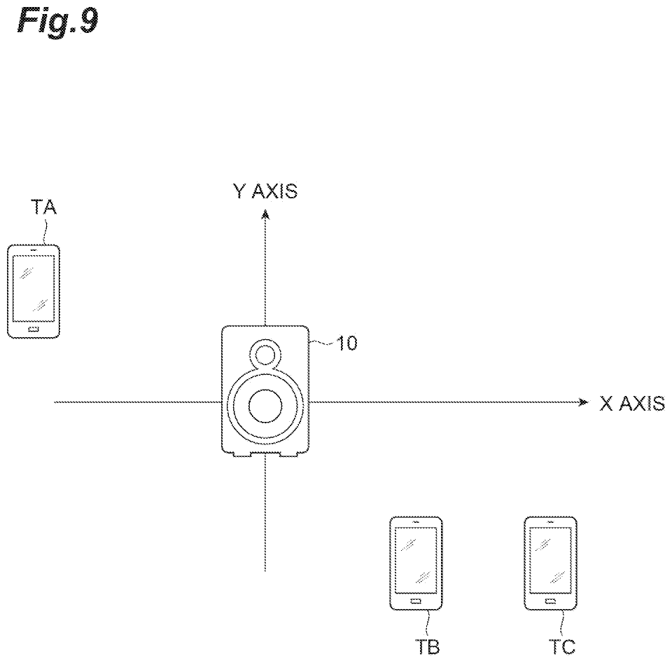

FIG. 9 is a diagram illustrating a third example of predetermined conditions associated with a position of a terminal for determining whether wireless connection is to be performed. The determination unit 12 determines that wireless connection to a terminal T of which a positional relationship with the wireless connection device 10 is a preset specific positional relationship is to be performed out of a plurality of terminals TA, TB, and TC of which terminal state information indicates the predetermined state in which a user is using the corresponding terminal T.

Specifically, for example, it may be determined that wireless connection to a terminal T present in a predetermined range (space) in a coordinate space in which the position of the wireless connection device 10 is defined as an origin, a front direction and a lateral direction of the wireless connection device 10 are defined as a Y-axis direction and an X-axis direction, and a direction perpendicular thereto is defined as a Z direction is to be performed. The terminal position acquiring unit 14 acquires relative positions of the plurality of terminals TA, TB, and TC of which terminal state information indicates the predetermined state in which a user is using the corresponding terminal T with respect to the wireless connection device 10 on the basis of information detected by the terminal position sensor 15. In the example illustrated in FIG. 9, when wireless connection to a terminal T present in a space of Y>0 in a coordinate space centered on the position of the wireless connection device 10 is assumed to be performed, the determination unit 12 determines that wireless connection to the terminal TA with a Y coordinate value greater than 0 is to be performed.

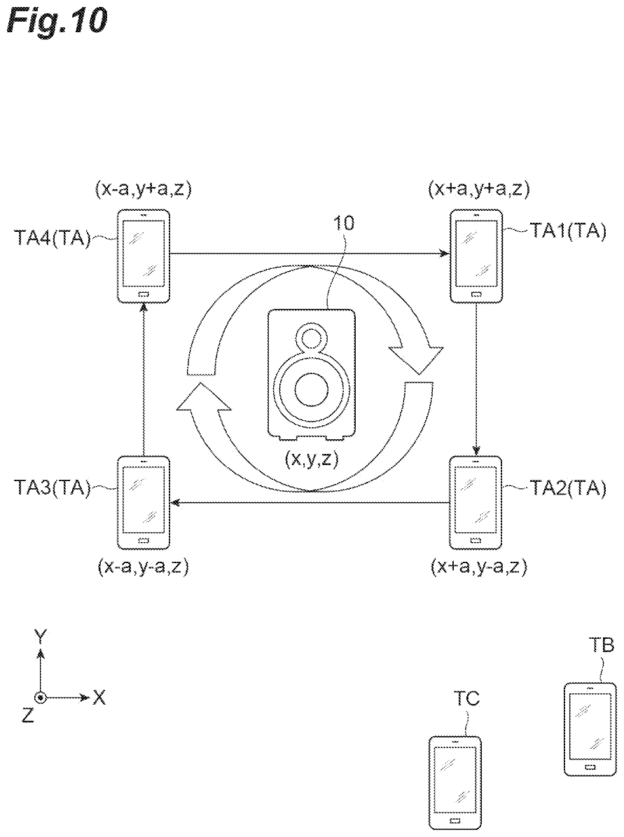

FIG. 10 is a diagram illustrating a fourth example of predetermined conditions associated with a position of a terminal for determining whether wireless connection is to be performed. The determination unit 12 determines that wireless connection to a terminal T of which a change in position relative to the wireless connection device 10 is a preset specific change is to be performed out of a plurality of terminals TA, TB, and TC of which terminal state information indicates the predetermined state in which a user is using the corresponding terminal T.

Specifically, for example, it may be determined that wireless connection to a terminal T having performed predetermined movement in a coordinate space in which the position of the wireless connection device 10 is defined as an origin, a front direction and a lateral direction of the wireless connection device 10 are defined as a Y-axis direction and an X-axis direction, and a direction perpendicular thereto is defined as a Z direction is to be performed. The terminal position acquiring unit 14 acquires changes in relative position of the plurality of terminals TA, TB, and TC of which terminal state information indicates the predetermined state in which a user is using the corresponding terminal T with respect to the wireless connection device 10 on the basis of information detected by the terminal position sensor 15. In the example illustrated in FIG. 10, when wireless connection to a terminal T having moved around the wireless connection device 10 on an XY plane is assumed to be performed, the determination unit 12 determines that wireless connection to the terminal TA having moved around the wireless connection device 10 is to be performed as indicated by arrows (TA1→TA2→TA3→TA4).

An example in which terminal position information is acquired when the terminal position sensor 15 is formed by a depth sensor will be described below. The terminal position sensor 15 formed by an existing depth sensor detects a distance to a terminal T present near the wireless connection device 10. The terminal position acquiring unit 14 acquires the distance to the terminal T as terminal position information from the terminal position sensor 15. The determination unit 12 identifies the terminal T on the basis of a user's image (for example, a face image) captured by the camera 16. Specifically, for example, it is assumed that the wireless connection device 10 include first correlation information in which a user' image (face image) and identification information of the user are correlated and second correlation information in which identification information of a user and identification information of a terminal T carried by the user are correlated. Then, the determination unit 12 acquires an image of a user carrying a terminal T of which a distance from the wireless connection device 10 has been detected by the depth sensor (a face image located near the terminal T) using the camera 16 and acquires identification information of the terminal T on the basis of the acquired image (face image) with reference to the first correlation information and the second correlation information. Then, the determination unit 12 determines that wireless connection to the terminal T is to be performed when a position of the terminal T indicated by the terminal position information of the terminal T of which identification information has been acquired (a distance to the terminal T acquired by the depth sensor) satisfies predetermined conditions.

When the determination unit 12 determines in Step S13 that the user is not using the terminal T or when the user is using the terminal T and the position of the terminal T is determined not to satisfy the predetermined conditions described above with reference to FIGS. 7 to 10, the routine proceeds to Step S14. In Step S14, the determination unit 12 determines that wireless connection to the terminal T is not to be performed.

In Step S15, the connection processing unit 13 of the wireless connection device 10 transmits a connection request based on a predetermined communication protocol to the terminal T to which it is determined that connection is to be performed in Step S13.

In Step S16, wireless connection is set up between the terminal T having received the connection request and the wireless connection device 10 after predetermined information based on a communication protocol has been transmitted and received therebetween.

In Step S17, transmission and reception of packet data between the terminal T and the wireless connection device 10 is performed, for example, in a manner including a request for data and a response thereto.

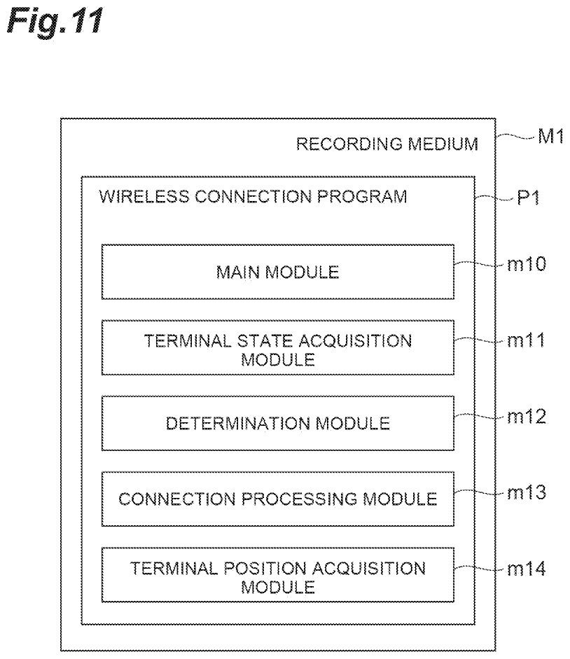

A wireless connection program for causing a computer to serve as the wireless connection device 10 according to the embodiment. FIG. 11 is a diagram illustrating a configuration of a wireless connection program.

The wireless connection program P1 includes a main module m10 that comprehensively controls the wireless connection process in the wireless connection device 10, a terminal state acquisition module m11, a determination module m12, a connection processing module m13, and a terminal position acquisition module m14. The functions of the terminal state acquiring unit 11, the determination unit 12, the connection processing unit 13, and the terminal position acquiring unit 14 are realized by the modules m11 to m14.

The wireless connection program P1 may be transmitted via a transmission medium such as a communication circuit or may be stored in a storage medium M1 as illustrated in FIG. 11.

In the wireless connection device 10, the wireless connection method, and the wireless connection program P1 according to the embodiment, since terminal state information indicating a state of a terminal T is acquired, the wireless connection device 10 may recognize whether the terminal T is in the predetermined state in which a user is using the terminal T1. Accordingly, a terminal T which is being used by a user may be connected to the wireless connection device 10 as a desired terminal.

In a wireless connection device according to another aspect, the predetermined state indicating that a user is using a terminal may include at least one of a state in which a screen of the terminal is being displayed, a state in which an operation to the terminal is ready to be received, and a state in which the user's operation has been detected by a predetermined sensor mounted in the terminal.

According to this aspect, since it is determined that a terminal is in the predetermined state by detecting an event with a high likelihood that a user grips and operates the terminal, whether the user is using the terminal may be appropriately determined.

A wireless connection device according to another aspect may further include a terminal position acquiring unit configured to acquire terminal position information indicating a position of the terminal, and the determination unit may determine to set up wireless connection to the terminal of which the terminal state information indicates the predetermine state in which the user is using the terminal and of which the position indicated by the terminal position information satisfies predetermined conditions.

According to this aspect, it is determined that wireless connection to a terminal which is in the predetermined state indicating that the terminal is being used by a user and of which a position satisfies the predetermined conditions is to be performed. Accordingly, even when a plurality of terminals which are being used by users are in a communication coverage of the wireless connection device, a desired terminal may be connected to the wireless connection device by causing a user to appropriately handle the terminal at a position at which the predetermined conditions are satisfied.

In a wireless connection device according to another aspect, the predetermined conditions associated with the position of the terminal may include a condition that the terminal is one of: a terminal with a largest decreasing distance to the wireless connection device per predetermined unit time; a terminal with a smallest distance to the wireless connection device; a terminal of which a positional relationship with the wireless connection device is a preset specific positional relationship; and a terminal of which a change of a position relative to the wireless connection device is a preset specific change, out of a plurality of the terminals in the predetermined state.

According to this aspect, a terminal desired by a user may be connected to the wireless connection device by causing the user to handle a terminal such that the predetermined conditions are satisfied.

A wireless connection device according to another aspect may further include an imaging device, the terminal position acquiring unit may acquire the terminal position information using a depth sensor, and the determination unit may identify the terminal on the basis of an image of a user carrying the terminal acquired by the imaging device and determine the terminal to be wirelessly connected on the basis of the position of the terminal acquired by the depth sensor.

According to this aspect, a terminal satisfying the predetermined conditions may be identified using an image of a user gripping the terminal. Accordingly, a terminal desired by a user may be appropriately connected to the wireless connection device.

While the present disclosure has been described above in detail, it will be apparent to those skilled in the art that the present disclosure is not limited to the embodiments described in the present disclosure. The present disclosure may be altered and modified in various forms without departing from the gist and scope of the present disclosure defined by description in the appended claims. Accordingly, the description in the present disclosure is for exemplary explanation and does not have any restrictive meaning for the present disclosure.

The aspects/embodiments described in this specification may be applied to a system using LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA2000, UMB (Ultra Mobile Broadband), IEEE 802.11 (Wi-Fi), IEEE 802.16 (WiMAX), IEEE 802.20, UWB (Ultra-Wide Band), Bluetooth (registered trademark), or other appropriate systems and/or a next-generation system which is extended based thereon.

The order of processes, the sequences, the flowcharts, and the like of the aspects/embodiments described above in this specification may be changed unless conflictions arise. For example, in the methods described in this specification, various steps are described as elements of an exemplary order, but the methods are not limited to the described order.

Information or the like which is input or output may be stored in a specific place (for example, a memory) or may be managed using a management table. Information or the like which is input or output may be overwritten, updated, or added. Information or the like which is output may be deleted. Information or the like which is input may be transmitted to another device.

Determination may be performed using a value (0 or 1) which is expressed in one bit, may be performed using a Boolean value (true or false), or may be performed by comparison of numerical values (for example, comparison with a predetermined value).

The aspects/embodiments described in this specification may be used alone, may be used in combination, or may be switched during implementation thereof. Notifying of predetermined information (for example, notifying that “it is X”) is not limited to explicit notification, and may be performed by implicit notification (for example, notifying of the predetermined information is not performed).

While the present disclosure has been described above in detail, it will be apparent to those skilled in the art that the present disclosure is not limited to the embodiments described in the present disclosure. The present disclosure may be altered and modified in various forms without departing from the gist and scope of the present disclosure defined by description in the appended claims. Accordingly, the description in the present disclosure is for exemplary explanation and does not have any restrictive meaning for the present disclosure.

Regardless of whether it is called software, firmware, middleware, microcode, hardware description language, or another name, software may be widely construed to refer to a command, a command set, a code, a code segment, a program code, a program, a sub program, a software module, an application, a software application, a software package, a routine, a sub routine, an object, an executable file, an execution thread, a sequence, a function, or the like.

Software, a command and the like may be transmitted and received via a transmission medium. For example, when software is transmitted from a web site, a server, or another remote source using at least one of wired technology (such as a coaxial cable, an optical fiber cable, a twisted-pair wire, or a digital subscriber line (DSL)) and wireless technology (such as infrared rays or microwaves), the wired technology or wireless technology is included in the definition of the transmission medium.

Information, signals, and the like described in the present disclosure may be expressed using one of various different techniques. For example, data, an instruction, a command, information, a signal, a bit, a symbol, and a chip which may be mentioned in the overall description may be expressed by a voltage, a current, an electromagnetic wave, a magnetic field or magnetic particles, a photo field or photons, or an arbitrary combination thereof.

Terms described in the present disclosure and terms for understanding the present disclosure may be substituted with terms having the same or similar meanings.

The terms “system” and “network” used in the present disclosure may be used interchangeably.

Information, parameters, and the like described above in this specification may be expressed as absolute values, may be expressed as values relative to predetermined values, or may be expressed using other corresponding information.

The term “determining” or “determination” used in the present disclosure may include various types of operations. The term “determining” or “determination” may include cases in which judging, calculating, computing, processing, deriving, investigating, looking up, search, or inquiry (for example, looking up in a table, a database, or another data structure), and ascertaining are considered to be “determined.” The term “determining” or “determination” may include cases in which receiving (for example, receiving information), transmitting (for example, transmitting information), input, output, and accessing (for example, accessing data in a memory) are considered to be “determined.” The term “determining” or “determination” may include cases in which resolving, selecting, choosing, establishing, comparing, and the like are considered to be “determined.” That is, the term “determining” or “determination” may include cases in which a certain operation is considered to be “determined.” “Determining” may be replaced with “assuming,” “expecting,” “considering,” or the like.

The expression “based on” used in the present disclosure does not mean “based on only” unless otherwise described. In other words, the expression “based on” means both “based on only” and “based on at least.”

No reference to elements named with “first,” “second,” or the like used in this specification generally limit amounts or order of the elements. These naming may be used in the present disclosure as a convenient method for distinguishing two or more elements. Accordingly, reference to first and second elements does not mean that only two elements are employed or that a first element precedes a second element in any form.

When the terms “include” and “including” and modifications thereof are used in the present disclosure, the terms are intended to have a comprehensive meaning similar to the term “comprising.” The term “or” used in the present disclosure is not intended to mean an exclusive logical sum.

In this specification, two or more of any devices may be included unless the context or technical constraints dictate that only one device is included.

In the entire present disclosure, singular terms include plural referents unless the context or technical constraints dictate that a unit is singular.

### REFERENCE SIGNS LIST

1 Wireless connection system
10 Wireless connection device
11 Terminal state acquiring unit
12 Determination unit
13 Connection processing unit
14 Terminal position acquiring unit
15 Terminal position sensor
16 Camera
21 State acquiring unit
22 State notifying unit
M1 Recording medium
m10 Main module
m11 Terminal state acquiring module
m12 Determination module
m13 Connection processing module
m14 Terminal position acquiring module
P1 Wireless connection program
T Terminal

1-5. (canceled)

6. A wireless connection device comprising circuitry configured to:
acquire a wireless signal to recognize a presence of a terminal, wherein the wireless signal includes terminal state information;
determine that the terminal state information corresponds to a working state of the terminal indicating that a user is using the terminal; and
establish a wireless connection with the terminal using a predetermined protocol, in response to determining that the terminal state information corresponds to the working state.

7. The wireless connection device according to claim 6,
wherein the wireless connection device is a wireless speaker to establish a short-range wireless communication as the wireless connection, with a mobile phone as the terminal.

8. The wireless connection device according to claim 6,
wherein the working state indicates that a screen of the terminal is being displayed.

9. The wireless connection device according to claim 6,
wherein the working state indicates that the terminal is in an unlocked state.

10. The wireless connection device according to claim 6,
wherein the working state indicates that a user operation has been detected by a sensor mounted in the terminal.

11. The wireless connection device according to claim 10,
wherein the working state indicates that an acceleration of a movement of the terminal detected by an acceleration sensor as the sensor of the terminal, is greater than a predetermined value.

12. The wireless connection device according to claim 10,
wherein the working state indicates that an input to a touch panel of the terminal is detected by a touch sensor as the sensor of the terminal.

13. The wireless connection device according to claim 10,
wherein the working state indicates that a gripping of the terminal is detected by a grip sensor as the sensor of the terminal.

14. The wireless connection device according to claim 6,
wherein the wireless connection device further comprises a terminal position sensor configured to acquire terminal position information,
wherein the circuitry is further configured to determine that the terminal position information satisfies a predetermined condition, and
wherein the wireless connection is established with the terminal, in response to determining that the terminal state information corresponds to the working state and to determining that the terminal position information satisfies the predetermined condition.

15. The wireless connection device according to claim 14,
wherein the terminal position sensor is configured to acquire terminal position information of a plurality of terminals,
wherein the terminal position information includes at least one information selected from the group consisting of a position of the terminal, a change in position of the terminal relative to the wireless connection device, and a distance from the terminal to the wireless connection device, and
wherein the circuitry is further configured to select the terminal among the plurality of terminals, as having the terminal position information that satisfies the predetermined condition.

16. The wireless connection device according to claim 15,
wherein the predetermined condition is satisfied when the terminal position information of the terminal indicates a greatest decreasing distance to the wireless connection device per unit time, among the plurality of terminals.

17. The wireless connection device according to claim 15,
wherein the predetermined condition is satisfied when the terminal position information of the terminal indicates a closest distance to the wireless connection device, among the plurality of terminals.

18. The wireless connection device according to claim 15,
wherein the predetermined condition is satisfied when the terminal position information of the terminal indicates a predetermined positional relationship with the wireless connection device, among the plurality of terminals.

19. The wireless connection device according to claim 18,
wherein the predetermined positional relationship indicates that the terminal is located in a predetermined range in a coordinate space in which a position of the wireless connection device is defined as an origin.

20. The wireless connection device according to claim 15,
wherein the predetermined condition is satisfied when the terminal position information of the terminal indicates that the change in position of the terminal relative to the wireless connection device corresponds to a predetermined change in position of the terminal, among the plurality of terminals.

21. The wireless connection device according to claim 20,
wherein the predetermined change in position of the terminal indicates that the terminal has performed a predetermined movement in a coordinate space in which a position of the wireless connection device is defined as an origin.

22. The wireless connection device according to claim 21,
wherein the predetermined movement is a rotation movement to circle around the wireless connection device.

23. The wireless connection device according to claim 14,
wherein the wireless connection device further comprises a camera to capture an image of a user, and
wherein the circuitry is further configured to:
identify a target terminal carried by the user based on the image of the user; and
set the target terminal as the terminal to establish the wireless connection with.

24. The wireless connection device according to claim 23,
wherein the wireless connection device further comprises a storage storing:
a first correlation information that correlates the image of the user and an identification information of the user; and
a second correlation information that correlates the identification information of the user and an identification information of the target terminal, and
wherein the circuitry is further configured to:
acquire the image of the user, the first correlation information and the second correlation information;
acquire the identification information of the target terminal based on the acquired image of the user with reference to the acquired first correlation information and the acquired second correlation information; and
identify the target terminal based on the acquired identification information of the target terminal, to set the target terminal as the terminal to establish the wireless connection with.

25. A wireless connection device comprising:
a terminal state acquiring unit configured to acquire a wireless signal to recognize a presence of a terminal, wherein the wireless signal includes terminal state information indicating a state of the terminal;
a determination unit configured to determine that the terminal state information corresponds to a working state indicating that a user is using the terminal; and
a connection processing unit configured to establish a wireless connection with the terminal using a predetermined protocol, in response to determining the working state.
